(19) United States
(12) Patent Application Publication
(10) Pub. No.: US 2018/0351793 A1
(43) Pub. Date: Dec. 6, 2018

(54) SYSTEM AND METHOD FOR PROVIDING SECURE AND REDUNDANT COMMUNICATIONS AND PROCESSING FOR A COLLECTION OF INTERNET OF THINGS (IOT) DEVICES

(71) Applicants: James R Hunter, Malvern, PA (US); Lilia A Weber, Malvern, PA (US); Craig R Church, Malvern, PA (US); Andrew F Sanderson, Malvern, PA (US)

(72) Inventors: James R Hunter, Malvern, PA (US); Lilia A Weber, Malvern, PA (US); Craig R Church, Malvern, PA (US); Andrew F Sanderson, Malvern, PA (US)

(73) Assignee: UNISYS CORPORATION, Blue Bell, PA (US)

(21) Appl. No.: 15/613,624

(22) Filed: Jun. 5, 2017

(51) Int. Cl. H04L 12/24

(52) U.S. Cl. CPC H04L 41/082; H04L 45/028; H04L 41/22; H04L 41/0853

(57) ABSTRACT

This application relates in general to a method, apparatus, and article of manufacture for providing secure and redundant communications and processing for a collection of Internet of Things. An extreme way of providing high availability network functionality would be to duplicate every component of the network in a High Availability (HA) style cold standby mode. As long as there is some component, even one that is already in use performing other functions in the IoT network that can pinch hit for the failing component, then uptime can still be achieved and in a more cost effective way than completely duplicate HA fashion.

### RELATED APPLICATIONS

This application relates to the following commonly assigned U.S. Patents and U.S. Patent Applications:
a. Landis, et al., entitled COMPUTER SYSTEM PARA-VIRTUALIZATION USING A HYPERVISOR THAT IS IMPLEMENTED IN A PARTITION OF THE HOST SYSTEM, attorney docket no. TN333A, Ser. No. 10/575,632, filed Apr. 7, 2006, and now U.S. Pat. No. 7,984,108, issued Jul. 19, 2011;
b. Weber et al., entitled SECURE PARTITIONING WITH SHARED INPUT/OUTPUT, attorney docket no. TN535A, Ser. No. 12/955,127, filed Nov. 29, 2010, and now abandoned;
c. Landis, et al., entitled OPTIMIZED EXECUTION OF VIRTUALIZED SOFTWARE USING SECURELY PARTITIONED VIRTUALIZATION SYSTEM WITH DEDICATED RESOURCES, attorney docket no. TN581, Ser. No. 13/681,644, filed Nov. 20, 2012, and now abandoned;
d. Hunter et al., entitled ERROR RECOVERY IN SECURELY PARTITIONED VIRTUALIZATION SYSTEM WITH DEDICATED RESOURCES, attorney docket no. TN582, Ser. No. 13/681,634, and filed Nov. 20, 2012;
e. Sliwa, et al., entitled REDUCED SERVICE PARTITION VIRTUALIZATION SYSTEM AND METHOD, attorney docket no. TN606, Ser. No. 14/468,651, filed Aug. 26, 2014, currently pending and allowed;
f. Hunter et al., entitled DYNAMIC ALLOCATION AND ASSIGNMENT OF VIRTUAL FUNCTIONS WITHIN FABRIC, attorney docket no. TN616, Ser. No. 14/487,192, and filed Sep. 16, 2014, now U.S. Pat. No. 9,384,060, issued Mar. 17, 2016;
g. Hunter et al., RESET OF SINGLE ROOT PCI MANAGER AND PHYSICAL FUNCTIONS WITHIN A FABRIC, attorney docket No. TN618, Ser. No. 14/487,210, and filed Sep. 16, 2014, currently pending; and
h. Nahraand et al., NONSTOP COMPUTING FABRIC ARRANGEMENTS, attorney, docket no. TN630, Ser. No. 14/519,532, and filed Oct. 21, 2014, currently pending.

The above applications are incorporated by reference in their entirety as if they were recited herein.

### TECHNICAL FIELD

This application relates in general to a method, apparatus, and article of manufacture for providing secure and redundant communications and processing for a collection of Internet of Things (IoT) devices connected to a computer network and under control of an IoT Host Server.

### BACKGROUND

For anyone who relies on an IoT network for their 24/7 business needs, “100% uptime” of enough of its components to prevent a usage outage is critical. Given that “100% uptime“” has been a longtime goal/characteristic of Unisys and the products it delivers (e.g. Clearpath Forward HA), this segment of the IoT market aligns well with our core strengths and with our enterprise customer needs in various verticals we are already in.

There are many “large client” market segments which quickly come to mind, where this could be needed, e.g. “large client,” e.g. transportation, financial, manufacturing companies, which will very likely depend on IoT networks around the clock every day of the year). But even smaller companies using IoT for various purposes might have a need for “100% uptime” for certain aspects of their business, e.g. an IoT network to provide building perimeter/access security via surveillance devices, access devices, etc. A need exists to prevent a hardware or software failure of any component of an IoT network from causing a usage outage for the Client who is depending on the functionality associated with that component.

The benefit is of the present invention is that it may permit an IoT network to operate with improved uptime by providing some automated failover for some of the critical components of the network without requiring the cost of acquisition and installation of a fully redundant set of components. By allowing for specification of how device failures will be reconfigured in a controlled manner, the entire IoT network may remain operational within the possible performance of the remaining devices.

The present invention attempts to address the existing limitations in current IoT network and device monitoring according to the principles and example embodiments disclosed herein.

### SUMMARY

In accordance with the present invention, the above and other problems are solved by providing a solution for an IoT Configuration Lifecycle software package that initially configures, then monitors and proactively reconfigures components of an IoT network to ensure maximum IoT service uptime e.g. 100% in configurations where there is sufficient cross-connection to provide backup for any component.

The great utility of the invention is that a Client can rely on the functionality provided by the IoT network around the clock and around the year without concern of an outage that could cause a portion of the business to come to a standstill or could result in a breach of security, safety, or any other absolutely essential usage.

In one embodiment, the present invention corresponds to a method for configuring a set of network devices. The method comprises discovering all devices within an IoT network, recommending a network topography and node functionality using a set of defining parameters, obtaining configuration data and functionality modules for use within the IoT network, and uploading configuration data and functionality modules from the IoT Host to the IoT Edge devices and the IoT gateway devices. The IoT network comprising an IoT Host computer, one or more gateway devices, and a plurality of IoT Edge devices.

In another embodiment, the present invention corresponds to a computer program product for configuring a set of network devices comprising a non-transitory computer-readable medium comprising a set of instructions that when executed by a programmable computing device causes the computing device to implement a method for configuring a set of network devices. The method comprises discovering all devices within an IoT network, recommending a network topography and node functionality using a set of defining parameters, obtaining configuration data and functionality modules for use within the IoT network, and uploading configuration data and functionality modules from the IoT Host to the IoT Edge devices and the IoT gateway devices. The IoT network comprising an IoT Host computer, one or more gateway devices, and a plurality of IoT Edge devices.

In yet another embodiment, the present invention corresponds to a distributed computing system, having an IoT Host Computer, one or more Gateway devices, and a plurality of IoT Edge devices, for configuring a set of network devices. The IoT Host computer comprises an IoT Device Discovery module for discovering all devices within an IoT networka Gateway Config module for recommending a network topography and node functionality using a set of defining parameters, an IoT Device Config module for displaying an updated visual representation of the network topography and node functionality to a user terminal based upon the modifications to the one or more of the defining parameters, and IoT Host control module for uploading configuration data and functionality modules to the IoT Edge devices and the IoT gateway devices.

The foregoing has outlined rather broadly the features and technical advantages of the present invention in order that the detailed description of the invention that follows may be better understood. Additional features and advantages of the invention will be described hereinafter that form the subject of the claims of the invention. It should he appreciated by those skilled in the art that the conception and specific embodiment disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

Referring now to the drawings in which like reference numbers represent corresponding parts throughout:

FIG. 1 represents one potential embodiment of a IoT network connecting a plurality of IoT devices to an IoT Host Server via a communications network passing data thru multiple gateway-devices according to one embodiment of the present invention.

FIG. 2 illustrates a general purpose computing system for use in implementing as one or more computing embodiments of the present invention.

FIG. 3 illustrates an example IoT Host Server and one Gateway device according to another embodiment of the present invention.

FIG. 4 illustrates an example Remote Gateway device and plurality of IoT devices in the IoT network according to yet another embodiment of the present invention.

FIG. 5a illustrates an example operator interface module within the IoT Host server according to an embodiment of the present invention.

FIG. 5b illustrates example IoT network rendered for interaction by a user thru the operator interface module of the IoT Host server according to an embodiment of the present invention.

FIG. 6 illustrates an IoT Edge Device Discovery module within the IoT Host server according to another embodiment of the present invention.

FIG. 7 illustrates a System Monitor/Failover module within the IoT Host server according to an embodiment of the present invention.

FIG. 8a illustrates a Gateway Config module within the IoT Host server an example embodiment of the present invention.

FIG. 8b illustrates a Network Present module within the IoT Host server an example embodiment of the present invention.

FIG. 9 illustrates a flowchart of possible operations that may be performed according to an embodiment of the present invention.

FIG. 10 illustrates another flowchart of possible operations that may be performed according to an embodiment of the present invention.

### DETAILED DESCRIPTION

This application relates in general to a method, apparatus, and article of manufacture for providing secure and redundant communications and processing for a collection of Internet of Things.

Various embodiments of the present invention will be described in detail with reference to the drawings, wherein like reference numerals represent like parts and assemblies throughout the several views. Reference to various embodiments does not limit the scope of the invention, which is limited only by the scope of the claims attached hereto. Additionally, any examples set forth in this specification are not intended to be limiting and merely set forth some of the many possible embodiments for the claimed invention.

This application relates in general to a method, apparatus, and article of manufacture for providing secure and redundant communications and processing for a collection of Internet of Things. While an extreme way of providing this would be to duplicate every component of the network in an High Availability (HA-style) “cold standby” mode, this is not required by this solution. As long as there is some component, even one that is already in use performing other functions in the IoT network, that can “pinch hit” for the failing component, then uptime can still be achieved and in a more cost effective way than a “completely duplicate HA” fashion.

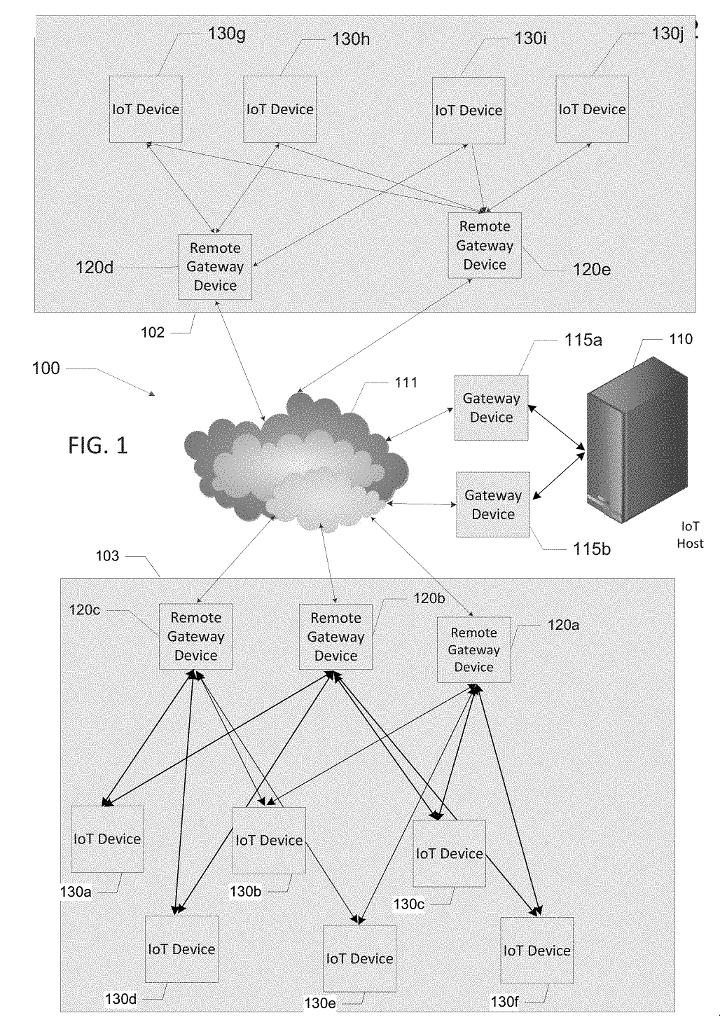

FIG. 1 illustrates an IoT Host computer 110 connected to a network 111 that is also connected to a first IoT network 102 of IoT edge devices 130a-130j and a second IoT network 103 of IoT edge devices 130a-130f. Both of the IoT networks 102-103 contain a plurality of IoT edge devices 103a-130j and one or more Remote Gateway devices 120a-120e. IoT Host 110 communicates with the IoT edge devices 130a-130j thru one or more gateway devices 115a-115b, network 111, and Remote Gateway devices 120a-120e. Each of the IoT edge devices 103a-130j may be connected to multiple Remote Gateway devices 120a-120e to provide multiple communications paths between the IoT edge devices 103a-130j and IoT Host 110. If a device fails in any part of this network, the multiple communication paths provide a mechanism to reestablish communications between the IoT edge devices 130a-130j and IoT Host 110.

While the present invention may make use of any unused IoT hardware to failover to, and could look for this possibility first, it would also gladly use unused bandwidth on an already-being-used IoT hardware component, e.g. path, gateway or edge device, at the time of a failure. Obviously, the more hardware cross-connections and the more available bandwidth that exists in an IoT network, the better, as that provides more failover choices. But once again, the key here is that this present invention obviates the need and cost of having fully redundant standby hardware and communications paths.

Depending on the topology of a particular IoT network and the failing component there could be different ways in which “100% uptime” could be achieved. In all cases, the solution would choose which secondary component(s) to use to replace the failing one(s). The strategy used to make any failover decision may be Administrator choosable: it can either be based on detailed, specific topology rules given in advance by the Administrator (Admin) for that particular network operating in an “expert mode” OR it can be based on a set of “general” load balancing rules in an “automated” mode that doesn't require Admin rules be given.

Expert mode would allow an Admin who wishes to pre-designate in fine-grained detail which component(s) is to provide backup processing for a particular failing component. For example, for a particular IoT edge device, the Admin could choose to designate which of a set of IoT Gateways would take over communications to the device in the event that the device's primary Gateway had failed. Or the Admin could choose which of different alternative paths would be used to connect to an IoT edge device should its primary path fail. This mode would require more upfront planning & decision making to be designated by the Admin, but would allow for detailed failover strategies tailored to the specific IoT network specified by the Admin, to be carried out by the underlying solution implementation.

Automated mode would be a simpler user interface (UI) that does not require detailed input from the Admin and would instead allow the Admin to inform the underlying solution of a more general strategy for failover component selection. For instance, in this mode, the Admin might choose a strategy such as “evenly load balanced” where the least busy used component is chosen or “round robin” where a failover component would be picked based on the most recent failover choice. These choices would allow the solution to make a reconfiguration choice based on a criteria such as “which of the possible failover components currently has the lightest load” or “choose a failover component different from the one we chose last time”, etc.

Either way, at failure time, the underlying solution will choose component(s) to replace the failing one(s) and then dynamically do the reconfiguration work necessary to reorient the network such that there won't be a service outage. The solution will also report the failure to an IoT Administrator so that the failed component can be scheduled for replacement. In the meantime, service will continue, though possibly degraded, depending on the amount of extra bandwidth available in the chosen replacement component(s) at the time of the failure.

For instance, the ability to failover an IoT gateway 115a, i.e. the main cloud gateway through which IoT traffic from IoT devices funnels into the IoT Host 110, is an example of providing “100% uptime” for one particular component type of an IoT network 102-103. Other IoT component types could fail (via either hardware breakage or software bug) and cause a failure to achieve “100% uptime”. For instance, the failure of a lone data path between an IoT edge device 130j and the IoT Remote Gateway 120e may cause a usage outage. Or, in larger IoT networks that employ multiple levels of gateways “outboard of the cloud,” e.g. the AZURE™ model allows for outboard IoT Protocol and IoT Field gateways (not shown), in addition to the inboard cloud IoT Remote Gateway, a hardware or software failure of an outboard gateway could cause an outage.

Additionally, an IoT edge device, that typically comprises a sensor, may also fail and cause an outage. All of the various pieces of an overall IoT network need to be considered/reconfigured in order to achieve “100% uptime” in the face of various IoT component failures. The present invention identifies failures of any device in an IoT network 102-103 and then chooses appropriate reconfiguration components before dynamically reconfiguring the IoT network to use chosen replacement devices.

Because of the large number of component failure and topology types that may require reconfiguration, rather than trying to design/implement replacement solutions for all of possible failures in one large waterfall model, the present invention breaks down and prioritizes various use cases, then orders the design/implementation of the overall solution to deal first with those use cases believed to be most likely to occur in the field. The actual implementation would consist of an application operating as a service that would most likely run on one or more “highest level” gateway(s) 115a-115b that have visibility to the overall IoT network. The service would direct the initial “primary” configuration of the overall IoT network 102-103, such as designating which IoT devices 130a-130j are served by which Remote Gateways 120a-120e via which paths during “normal running.”

The service(s) would then monitor the IoT network 102-103 for outages which would require reconfiguration that would redirect work to a “secondary” component. For instance, by generating & routing periodic “status” operations through the various paths and gateways to particular devices, the service could monitor the health of the IoT components. If there already exists “known periodic” traffic between the host(s) 110 and IoT edge device(s) 130a-130j, the service could track this traffic and when the service notices that traffic has not been generated for a particular period of time, the service may route its own status ops through the IoT network1 102-103 to quickly ascertain which IoT edge devices 130a-130j or Remote Gateways 120a-120e have failed, choose a replacement device based on how the Administrator specified that replacements would be chosen, do the reconfiguration, i.e. set up the routing in the appropriate gateways and/or devices for whichever gateway, path or device should be used instead of the failing one, and alert the Client with a notification. This notification may consist of a pop up message on a host service screen, an audible alarm, and/or an email/phone call or log entry, etc.

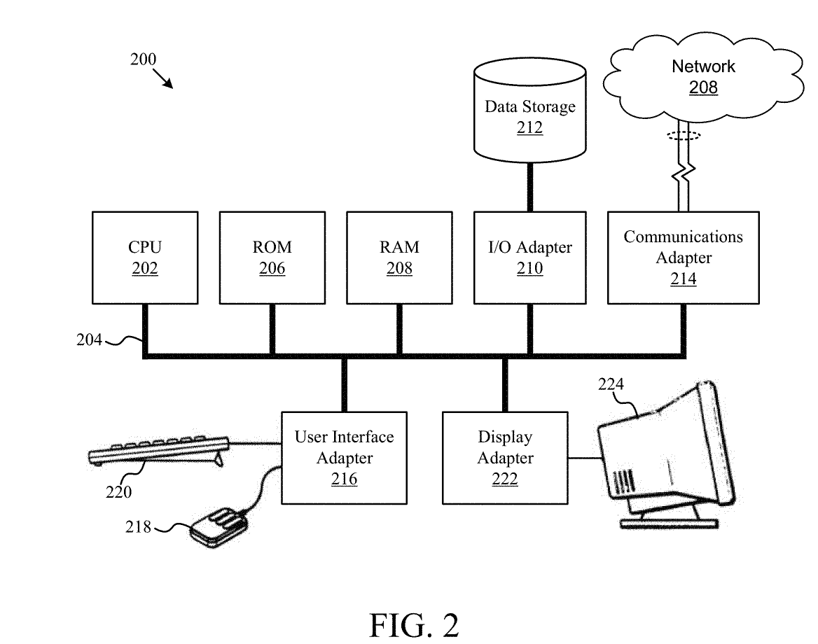

FIG. 2 illustrates a computer system 200 adapted according to certain embodiments of the server 102 and/or the client computer 101. The central processing unit (“CPU”) 202 is coupled to the system bus 204. The CPU 202 may be a general purpose CPU or microprocessor, graphics processing unit (“GPU”), and/or microcontroller. The present embodiments are not restricted by the architecture of the CPU 202 so long as the CPU 202, whether directly or indirectly, supports the operations as described herein. The CPU 202 may execute the various logical instructions according to the present embodiments.

The computer system 200 also may include random access memory (RAM) 208, which may be synchronous RAM (SRAM), dynamic RAM (DRAM), synchronous dynamic RAM (SDRAM), or the like. The computer system 200 may utilize RAM 208 to store the various data structures used by a software application. The computer system 200 may also include read only memory (ROM) 206 which ay be PROM, EPROM, EEPROM, optical storage, or the like. The ROM may store configuration information for booting the computer system 200. The RAM 208 and the ROM 206 hold user and system data, and both the RAM 208 and the ROM 206 may be randomly accessed.

The computer system 200 may also include an input/output (I/O) adapter 210, a communications adapter 214, a user interface adapter 216, and a display adapter 222. The I/O adapter 210 and/or the user interface adapter 216 may, in certain embodiments, enable a user to interact with the computer system 200. In a further embodiment, the display adapter 222 may display a graphical user interface (GUI) associated with a software or web-based application on a display device 224, such as a monitor or touch screen.

The I/O adapter 210 may couple one or more storage devices 212, such as one or more of a hard drive, a solid state storage device, a flash drive, a compact disc (CD) drive, a floppy disk drive, and a tape drive, to the computer system 200. According to one embodiment, the data storage 212 may be a separate server coupled to the computer system 200 through a network connection to the I/O adapter 210. The communications adapter 214 may be adapted to couple the computer system 200 to the network 208, which may be one or more of a LAN, WAN, and/or the Internet. The communications adapter 214 may also be adapted to couple the computer system 200 to other networks such as a global positioning system (GPS) or a Bluetooth network. The user interface adapter 216 couples user input devices, such as a keyboard 220, a pointing device 218, and/or a touch screen (not shown) to the computer system 200. The keyboard 220 may be an on-screen keyboard displayed on a touch panel. Additional devices (not show such as a camera, microphone, video camera, accelerometer, compass, and or gyroscope may be coupled to the user interface adapter 216. The display adapter 222 may be driven by the CPU 202 to control the display on the display device 224. Any of the devices 202-222 may be physical and/or logical.

The applications of the present disclosure are not limited to the architecture of computer system 200. Rather the computer system 200 is provided as an example of one type of computing device that may be adapted to perform the functions of a server 110 and/or the client computer 130, as shown in FIG. 1. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 200 may be virtualized for access by multiple users and/or applications.

Additionally, the embodiments described herein are implemented as logical operations performed by a computer. The logical operations of these various embodiments of the present invention are implemented (1) as a sequence of computer implemented steps or program modules running on a computing system and/or (2) as interconnected machine modules or hardware logic within the computing system. The implementation is a matter of choice dependent on the performance requirements of the computing system implementing the invention. Accordingly, the logical operations making up the embodiments of the invention described herein can be variously referred to as operations, steps, or modules.

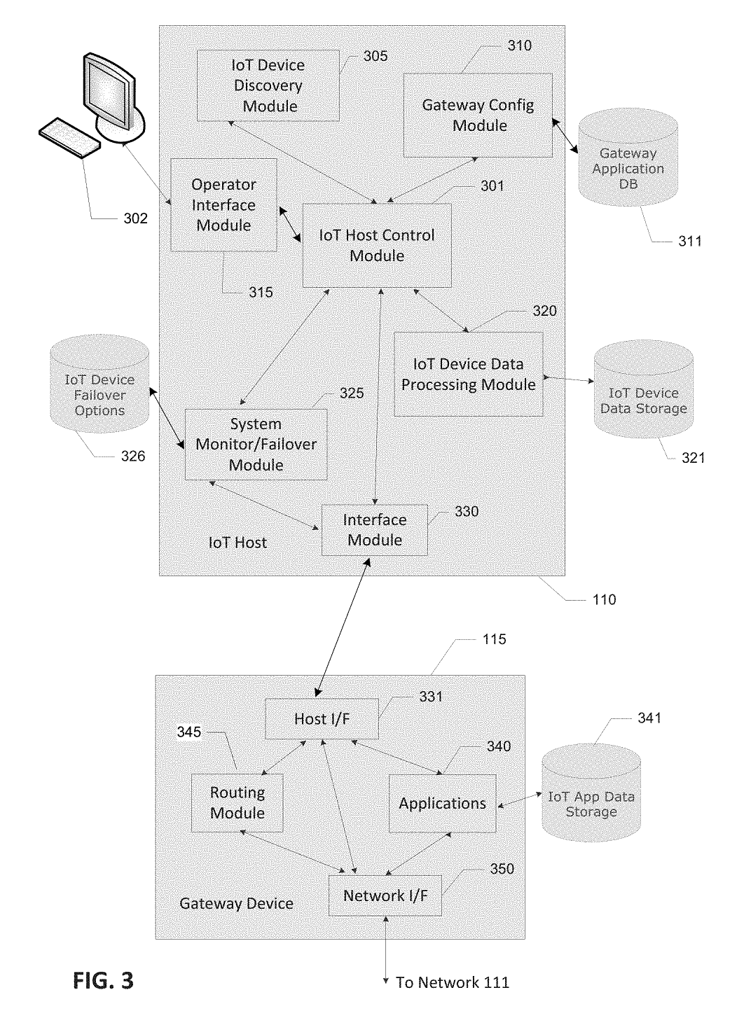

FIG. 3 illustrates an example IoT Host Server and one Gateway device according to another embodiment of the present invention. IoT Host 110 interacts with gateway device 115 to communicate with IoT edge devices via a network 111. IoT Host 110 comprises an IoT Host Control module 301, an operator interface module 315 connected to a user console 302, an IoT device discovery module 305, a gateway configuration module 310 coupled to a gateway application database 311, an IoT device data processing module 320 coupled to an IoT device data database 321, a system monitor/failover module 325 coupled to an IoT device failover options database 326, and an interface module 330 coupled to the gateway device 115.

The IoT Host Control module 301 is responsible for configuring, enabling, monitoring and controlling the operations of all of the modules within the IoT Host 110. At start up, the IoT Host Control module 301 configures the operation of the other modules and initiates any necessary interaction between any of these modules and each other as well as with Remote Gateway devices and/or IoT edge devices. During operation, the IoT Host Control module 301 monitors the operation of all other functions within the IoT Host 110 and will initiate any needed actions when an anomaly arises. The IoT Host Control module 301 may utilize other modules within the IoT Host 110 to deal with these issues as they arise. Through all of these interactions, the IoT Host Control module 301 will control the operation of the entire system.

The operator interface module 315 connected to the user console 302 provides a mechanism for an operator to observe and control the functions within the IoT Host 110. The operator interface module 315 provides a user interface to control functions and monitoring data within the IoT Host control module 301. The operator interface module 315 provides the data to the operator and accepts commands that start, stop, and alter the operation of the system. The operator interface module 315 provides a communications function to communicate with the user console 302 either as a console directly connected to the IoT Host 110 as well as to a remote client(s) executing on a remote computing system(s) that is connected to a communications network. Someone of ordinary skill will recognize that the remote client may either be a client application or a terminal emulation program without deviating from the present invention. Additionally, the operator interface module 315 may communicate with the remote client vie network 111, thru interface module 330, or using a separate communications connection between the operator interface module 315 and the remote console.

The IoT device discovery module 305 is responsible for determining the topography of the IoT network 103 as shown in FIG. 1. At network startup, the IoT device discovery module 305 will identify all of the IoT edge devices 130a-j and all of the Remote Gateway devices 120a-e in the IoT network 102-103. The IoT device discovery module 305 also discovers all of the communications connections and paths between all of the devices in the IoT networks 102-103. From this data, the IoT device discovery module 305 may construct a complete topography of the IoT networks 102 and 103.

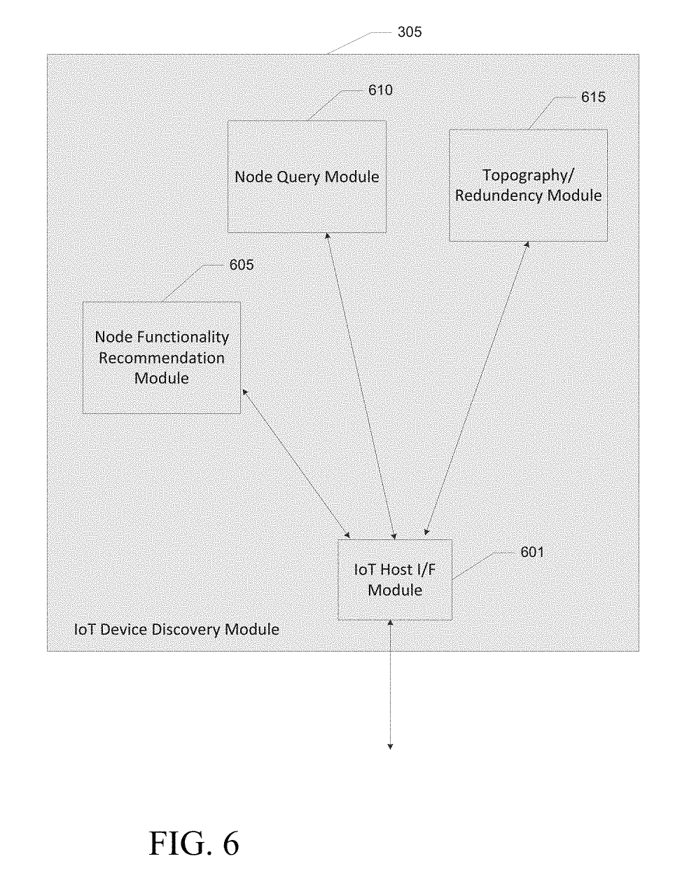

The IoT device discovery module 305 may obtain all the necessary data by sending a discovery request to all of the devices within the IoT networks 102-103. Each of these devices forward the discovery request to all of the devices connected to the device. The devices in IoT networks 102-103 will respond to the first request by returning to the IoT device discovery module 305 its identity, its location, an identity of all of the devices directly attached to the device, and an identifier for every communications link between each of the devices. The IoT device discovery module 305 is discussed in additional detail in reference to FIG. 6 below.

The gateway configuration module 310 is responsible for configuring the operation of the attached gateway device 115 and the Remote Gateway devices 120a-e. The gateway configuration module 310 obtains all configuration data and applications that are to be loaded into the various gateway devices and provides the data and applications when a gateway device is either started or reconfigured. The gateway configuration module 310 is coupled to gateway application database 311 to store all of the configuration data and applications needed for the above processing.

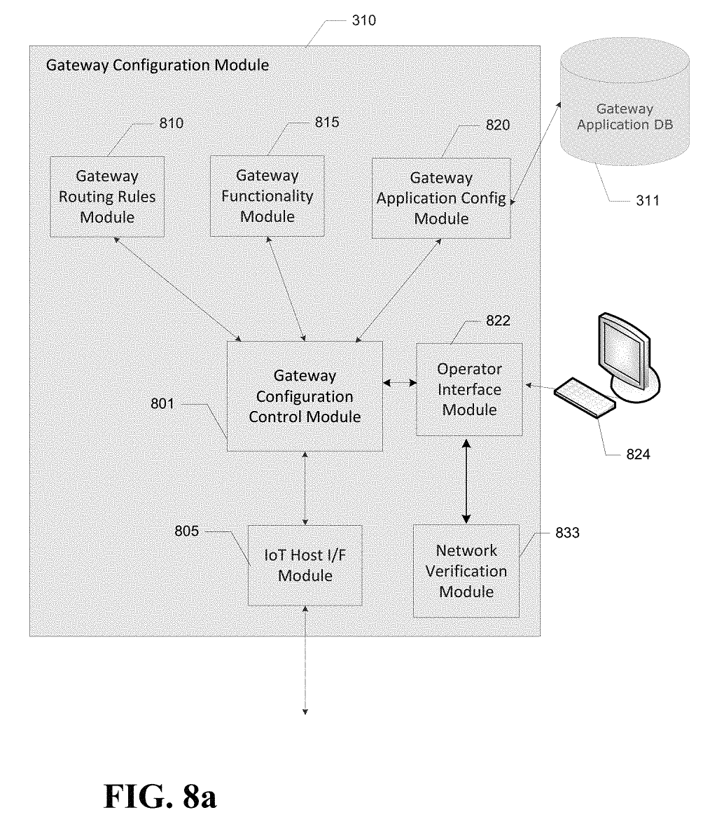

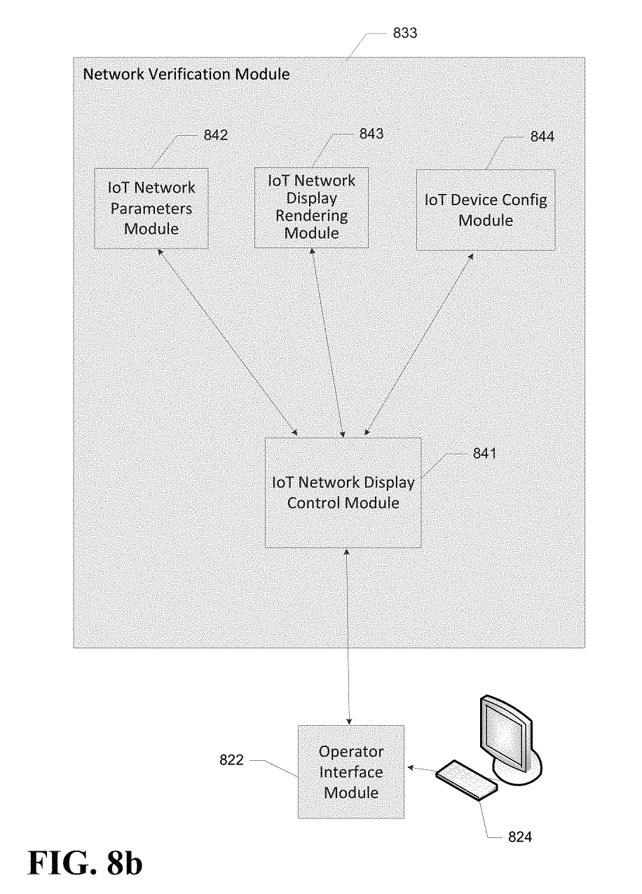

The IoT device data processing module 320 is responsible for obtaining data from the IoT edge devices 130a-j while the IoT networks 102-103 are operating. Depending upon the function of the IoT edge devices 130a-j, the gateway configuration module 310 may perform processing operations necessary for the IoT networks 102-103 to perform a desired operation. For example, IoT edge devices 130a-j may consist of various sensor devices. The gateway configuration module 310 may perform data filtering, averaging, and alarm triggering functions based upon the sensor data obtained from the IoT edge devices. The present invention envisions that the gateway configuration module 310 perform any necessary operations as defined when a system 100 is designed. The gateway configuration module 310 is coupled to the IoT device data database 321 as attached storage to store and manage any of the data needed to perform the sensor data processing functions. Additionally, log files and other diagnostic data from the operation of the IoT networks 102-103 may be stored in the attached database 321 for retrieval and analysis at a later time. Additional functions and operation of the gateway configuration module 310 are described below in reference to FIG. 8.

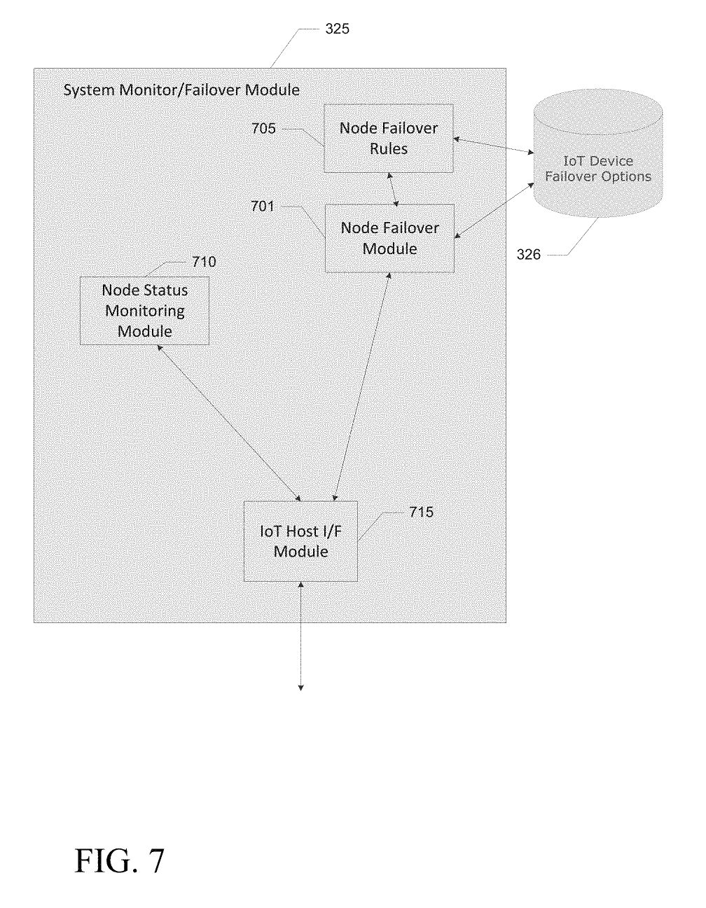

The system monitor/failover module 325 is responsible for detecting an occurrence of an anomaly within the operation of IoT networks 102-103 and for attempting to reconfigure the functions of IoT networks 102-103 and their devices to maintain operation of the IoT networks 102-103. In some embodiments, IoT networks 102-103 may possess redundant IoT edge devices 130a-j and redundant Remote Gateway devices 120a-e. When one of these types of devices fails or otherwise is not operating as desired, the system monitor/failover module 325 determines the nature of the anomaly, identifies possible replacement device and/or communications paths, and initiates a reconfiguration of devices within IoT networks 102-103. The system monitor/failover module 325 obtains failover options data from the IoT device failover options database 326. The system monitor/failover module 325 may reconfigure the needed devices directly, or may instruct the gateway configuration module 310 to perform the reconfiguration. In the latter embodiment, the system monitor/failover module 325 may pass to the gateway configuration module 310 the identity of the devices to be reconfigured and the identity of a configuration role for that device. Additional details regarding the system monitor/failover module 325 may be found below in reference to FIG. 7.

The interface module 330 provides communications for the IoT Host 110 to its local gateway device 115. The interface module 330 permits the communications to flow as required while utilizing a particular protocol and transport mechanism. The interface module 330 prioritizes the communications from all of the modules within the IoT Host 110 to ensure that a priority between possible communications s provided. For example, the interface module 330 may perform communications related to a failover and/or an alarm process that may be considered critical over the routine transmission of IoT edge device data and/or routine status updates. The interface module 330 may implement a priority scheme to ensure that critical issues are resolved before routine operations or any other desired arrangement.

The gateway device 115 comprises a host interface module 331, a routing module 345, an applications module 340 coupled to an IoT application data storage 341, and a network interface module 350. The host interface module 331 performs the converse of the operations of the interface module 330 within the IoT Host 110. Data is transmitted to and from the interface module 330 in the desired protocol over the implemented transport mechanism. The host interface module 331 communicates and coordinates the transfer of data and commands as requested by the interface module 330 to realize any priority scheme discussed above.

The routing module 345 utilizes the network topography for IoT networks 102-103 that is created within the IoT device discovery module 305 and utilizes routing rules from the gateway configuration module 310 to route communications to and from the IoT edge devices in IoT networks 102-103. The routing module 345 may maintain a routing table that contains a hierarchical routing table that specifies all of the possible communications paths from the IoT Host 110 and any one of the IoT edge devices 130a-j. The table may also provide an order for the path to be chosen to route the communications within IoT networks 102-103. In many embodiments, the routing table data is updated at system configuration and at any or all failover reconfiguration events. In such an embodiment, the routing data is static.

In an alternate embodiment, the routing module may monitor the performance of the IoT networks 102-103 communications as measured in any number of ways to identify parts of the network that may be experiencing higher levels of message traffic and in such cases, choose alternate communications paths to attempt to balance the communication load across all of the affected communications paths. The routing module 345 may attempt to measure these message traffic levels by examining any observed latency from the gateway device 115 receiving acknowledgement of messages and commands. The routing module 345 may use an indication of the number of pending messages and commands within any communications buffers within the networks 102-103 to approximate message traffic loads.

The applications module 340 supports any application functions requested during configuration to process data from IoT edge devices before the data is forwarded to the IoT Host 110. As noted above, data from the IoT edge devices may represent time sampled data from sensor devices that may require filtering, averaging, and other similar processing before the sensor data may be useful. The gateway devices 115 and Remote Gateway devices 120a-e are envisioned to be programmable computing devices possibly within the network infrastructure. These devices typically possess unused computational capacity and may be sized to provide a desired level of computational capacity, to permit the large amount of data that is expected to be generated by a network of IoT edge devices to be efficiently processed at the various gateway devices within the IoT networks 102-103 while reducing the amount of data that needs to be communicated through the network to the IoT Host 110. The applications module 340 may use the IoT application data storage 341 to store, organize and maintain data from its processing of the IoT edge device data for use at a later date when necessary.

Additionally, applications module 340 may utilize a Docker containerized application that permits an application to execute as a self-contained virtual computing system that implements the desired application function. The container may include an application and a small OS kernel including any needed function libraries to permit the application to function. The Remote Gateway device 120a-e may permit these containers to execute as a virtual computing device within itself to implement any desired functionality. Because a container may be launched within any device supporting these virtual computing applications and also contain any application written and configured to execute within the container, any functionality needed may be supported within a gateway device 115, 120. Additionally, the functionality of the gateway device may be altered by starting a new containerized application within a gateway device. The new application may either replace an existing application or add an additional application to the gateway device. The number of virtual applications that may exist within a given gateway device is limited by the computing resources of the gateway devices. Large numbers of virtualized applications within these containers may be supported by a single computing system if there is sufficient memory, network bandwidth, and CPU support to provide the processing needed by these applications. Gateway devices may be implemented with computing components to support these requirements.

The network interface module 350 provides an interface between the gateway device 115 and the main communications network 111. Because this network 111 may include both private and public networks, the network interface module 350 may also provide security between itself and a corresponding Remote Gateway module 120a-e over these more generally accessible data networks. Someone of ordinary skill will also recognize that the security functionality may also be located elsewhere in the IoT Host 110 should the communications between the IoT Host 110 and the gateway device 115 also utilize accessible communications networks.

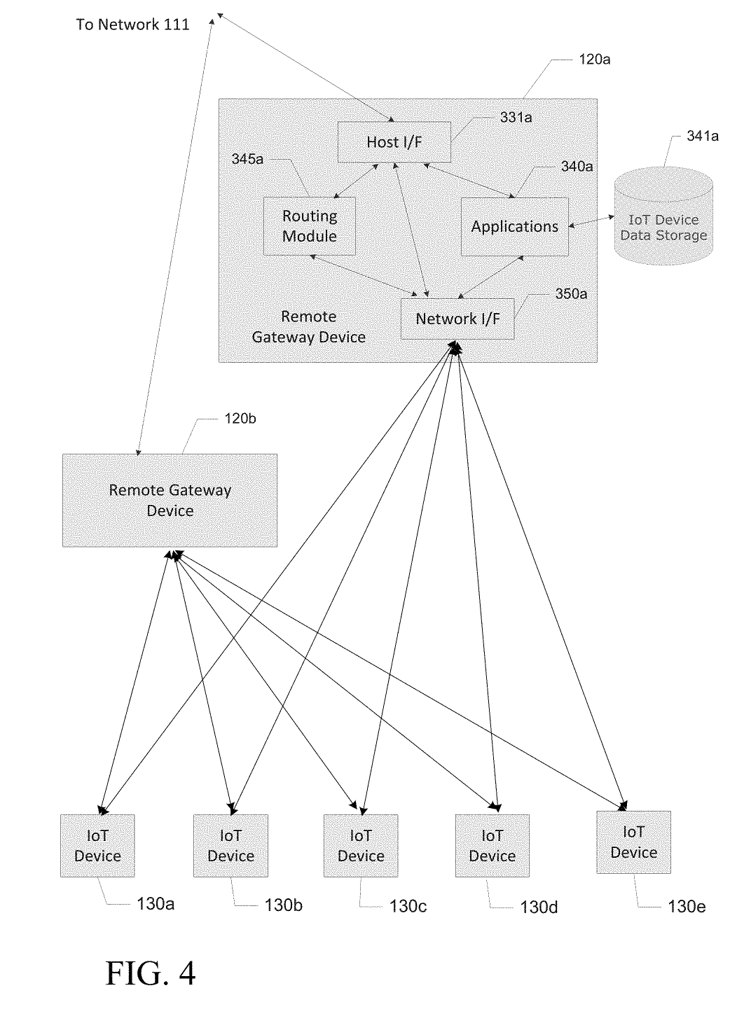

FIG. 4 illustrates an example of Remote Gateway devices and plurality of IoT devices in the IoT network according to yet another embodiment of the present invention. Within IoT network 103, multiple Remote Gateway devices 120a-h may be included to support a large number of IoT edge devices 130a-e. In the embodiment of FIG. 4, two Remote Gateway devices 20a-b are shown supporting five IoT edge devise 130a-e. Both of the Remote Gateway devices 120a-b are connected to the network 111 for communications to the IoT Host 110 via the Remote Gateway device 115 attached to the host 110. Additionally, both Remote Gateway devices 120a-b are also connected to all five IoT edge devices 130a-e. When the IoT Host 110 communicates with one of the IoT edge devices 130a-e, the message traffic may be transmitted via either Remote Gateway device 120a-b with the utilized Remote Gateway device using its connection to the particular IoT edge device 130a-e. Should one of the remote gateway devices 120a-b or one of their connections to the particular IoT edge device fail, an alternate path may be used via the other Remote Gateway device. The number of multiple communications paths and thus alternate ways of communicating between the IoT Host 110 and the IoT edge devices depend upon the network topography of IoT network 103 and the number of devices existing in parallel.

In a typical embodiment in which the IoT edge devices comprise sensors, the number of Remote Gateway devices 120a-b and whether the particular gateway device connects to an individual IoT sensor may also depend upon the type of sensor within the IoT edge device, the physical location of the IoT sensors, the amount of data to be transmitted by the IoT sensor, and any number of other factors. If the sensors are measuring conditions across a large physical space, the number and location of the sensors may determine the connections and number of Remote Gateway devices used as well as the cost in installing the sensors and connections to the Remote Gateway devices.

The connections between the Remote Gateway devices 120a-b and the IoT edge devices 130a-e may be implemented using any type of communications protocol and communications transport that is supported by both the Remote Gateway devices and the IoT edge devices. These connections may be wired connections or wireless connections that may implement secure or unsecure communications as needed by the implementation. Examples of protocols that may be supported, but are not limited to, are Wifi, LoRaWAN, wired Ethernet, serial, Bluetooth, Zigbee, 4G Cellular, and fiber channel connections.

Within each Remote Gateway device 120a-b, the devices include a host interface module 331, a routing module 345, an applications module 340, and a network interface module 350. The Applications module 340 may be coupled to an IoT application data storage database 341. All of these modules perform the functions described above with respect to the gateway device 115 of FIG. 3. Each of these Remote Gateway devices 120a-b control the portion of the IoT network 103 within its connections. In addition, alternative embodiments, may utilize multiple levels of Remote Gateway devices when appropriate because of the number of connections, the geographic locations to be covered, and similar factors that relate to design of a network. The Applications module 340 also supports the Docker containerized application functionality described above in reference to FIG. 3.

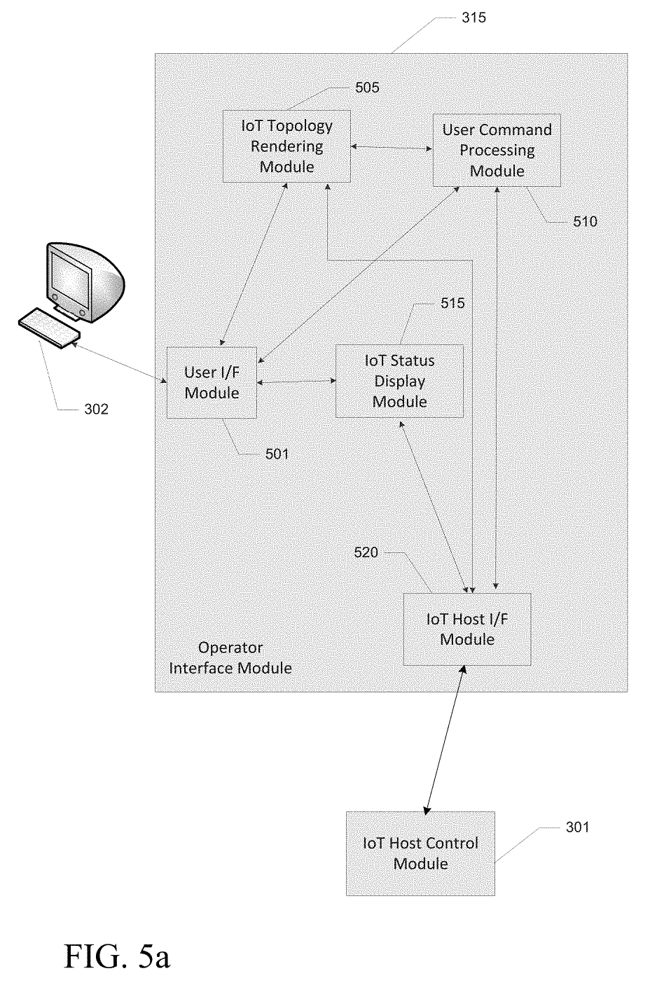

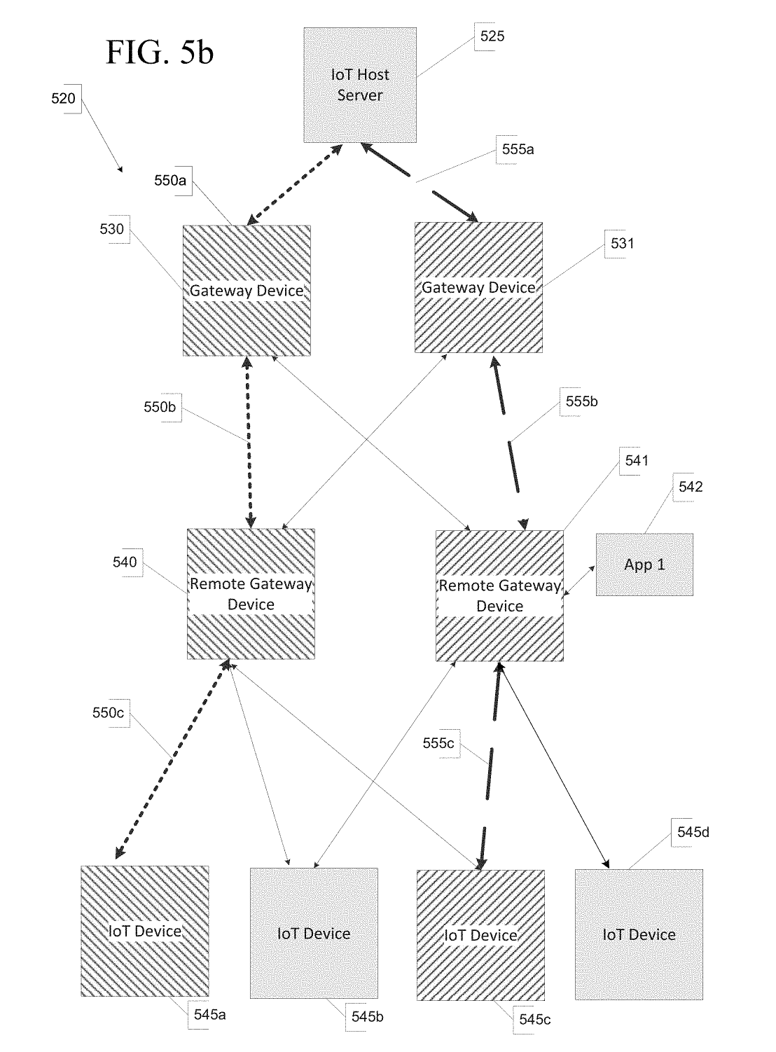

FIG. 5a illustrates an example operator interface module within the IoT Host server according to an embodiment of the present invention. The Operator Interface module 315 includes an IoT Host Interface module 520, an IoT Status Display module 515, a User Interface module 501, an IoT Topography Rendering module 505, and a User Command Processing module 510. The User Interface module is connected to a user console 302 to display data to an operator and to accept inputs to initiate commands.

The IoT Host-Command interface module 520 is connected to the IoT Host Control module 301 to provide a connection from the user console 302 to the operation of IoT Host 110. The IoT Host-Command Interface module 520 also connects to the IoT Status Display module 515, the User Interface module 501, the IoT Topography Rendering module 505, and the User Command Processing module 510 within the Operator Interface module 315 for facilitating the interaction of the IoT Host 110 and all of the functions supported by the Operator Interface module 315.

The IoT Status Display module 515 prepares a display of the current status of the IoT networks 102-103 and its devices to the user console 302. The IoT Status Display module 515 obtains the status information from the IoT Host Control module 301 and formats the data to match a user interface (UI) that is to be presented on the user console 302. The IoT Status Display module 515 communicates with the user console 302 via the User Interface module 501.

The User Interface module 501 provides a communications interface between the Operator Interface module 315 and the user console 302. The module 501 provides the data formatting for the protocol and transport mechanism needed to communicate with the user console 302. As such, all of the modules in the Operator Interface module 315 may communicate with the user console 302 regardless of the type of connection used to communicate with the user console 302. As noted above, the connection may be a wireless connection, a network connection, or a direct wired connection.

The IoT Topography Rendering module 505 prepares a display of the current topography of the IoT networks 102-103 and their devices to the user console 302. The IoT Topography Rendering module 505 obtains the status information from the IoT Host Control module 301 and formats the data to match a user interface (UI) that is to be presented on the user console 302. The IoT Topography Rendering module 505 communicates with the user console 302 via the User Interface module 501.

The User Command Processing module 510 receives commands initiated by an operator via the user console 302 and generates all necessary requests to other modules within the IoT Host 110 to implement the command. The user command processing module 510 communicates with the user console 302 via the user interface module 501. The user command processing module 510 communicates with other modules within the IoT Host 110 via the IoT Host-Command Interface module 520. For most commands, the User Command Processing module 510 will communicate with the IoT Host Control module 301 when initiating the user commands; however someone of ordinary skill in the art will recognize that the User Command Processing module 510 may directly communicate with any module within the IoT Host 110 to initiate a command.

FIG. 5b illustrates example IoT network rendered for interaction by a user thru the operator interface module of the IoT Host server according to an embodiment of the present invention. The example IoT network 520 presents a graphical display of the topography of the IoT network 520 as well as the status of individual devices within the network 520. The display contains graphical objects representing the IoT Host 525, a plurality of gateway devices 530-531, a plurality of Remote Gateway devices 540-541, and a plurality of IoT edge devices 545a-d.

The graphical objects within the IoT network 520 may also provide graphical information corresponding to the status of the devices within the network 520. Active devices may be presented with one type of graphic pattern and/or color. Inactive devices and failed devices may be presented with other types of graphic patterns and colors. Additionally, the types of graphic patterns and colors may also present the type of IoT device, such as patterns that provide a distinction between two types of sensors.

Within FIG. 5b, gateway 530, Remote Gateway device 540, and IoT device 545a are displayed having a first graphic pattern corresponding to one type of sensor; gateway 531, Remote Gateway device 541, and IoT device 545c are displayed having a second graphic pattern corresponding to a second type of sensor.

The IoT network 520 also may display communications links between these modules using different patterns and/or colors. Communication links 550a, 550b, and 550c are displayed using a first pattern to illustrate a primary communications path between IoT Host 525 and IoT edge device 545a. Similarly, communication links 555a, 555b, and 555c are displayed using a second pattern to illustrate a primary communications path between IoT Host 525 and IoT edge device 545c. IoT edge devices 545b, 545d may also be shown as being inactive and redundant with a different pattern and color. If a gateway device 530-531 or a Remote Gateway device 540-541 includes a virtual containerized application 542, the existence and status of the application may also be displayed. Someone of ordinary skill in the art will recognize that the number of patterns, colors and types of status information may include any number and types of status data without deviating from the present invention as recited in the attached claims.

FIG. 6 illustrates an IoT Edge Device Discovery within the IoT Host server according to another embodiment of the present invention. The IoT Edge Device Discovery module 305 communicates with all of the devices in IoT networks 102-103 to determine the status and topography of the networks. The IoT Edge Device Discovery module 305 contains a Node Query module 610, a Topography/Redundancy Module 615, a Node Functionality Recommendation module 605, and an IoT Host interface module 601.

The Node Query module 610 at start up sends out a broadcast command to all of the devices within the IoT networks 102-103 requesting its identity, its connected devices, and its status. Each of these devices forward the discovery request to all of the devices connected to the device. The discovery request will possess an ID or times tamp so that these devices may recognize when they are receiving multiple copies of the same request. The devices may only forward the first occurrence of the discovery request while ignoring the later requests. As such, the discovery request will eventually be received by all of the devices within IoT networks 102-103.

The devices in IoT networks 102-103 will respond to the first request by returning to the IoT device discovery module 305 its identity, its location, an identity of all of the devices directly attached to the device, and an identifier for every communications link between each of the devices. The IoT device discovery module 305 may also receive other status information regarding the devices health and operating status. All of the received data is then made available to the Topography/Redundancy Module 615.

Using all of the received data, the Topography/Redundancy Module 615 may construct a topography graph for the IoT networks 102-103. The topography graph may be maintained within the topography graph to permit the IoT Host control module 301 or the operator interface module 315 to obtain a current status for all of the devices and connection paths within IoT networks 102-103. The Topography graph contains all of the devices in the IoT networks 102-103, all of the connections between these devices, and is organized into a traversable graphs that illustrates every communications path from the IoT Host 110 and every IoT Edge Device 130. The Topography/Redundancy Module 615 identifies a primary communications path and all possible alternate communications paths to each IoT Edge Device 130.

The Node Functionality Recommendation module 605 utilizes the topography graph created in the Topography/Redundancy Module 615 to determine what, if any, applications may be needed in each of the Remote Gateway devices 120 to support the IoT edge devices. The Node Functionality Recommendation module 605 may use the number of IoT edge devices 130 that are connected to a particular Remote Gateway Device 120 to determine whether an application is best located at that Remote Gateway Device, or is best located at a higher or lower Gateway Device between the IoT Edge Device 130 and the IoT Host 110. Other factors in determining the applications needed by each of the Remote Gateway Devices 120 may include, the number of device types contained within primary communications paths thru the particular Gateway Device, an estimated amount of message traffic and corresponding data to be passing thru the particular Gateway Device, an estimate of the processing requirements for the estimated amount of traffic and data, and the resources available in other Remote Gateway devices. These recommendations may be made available to the Gateway Configuration Module 310 for use in configuring all of these devices.

The Host-Topography interface module 601 is connected to the IoT Host control module 301 to provide a connection from the Topography/Redundancy Module 615 to the IoT Host 110. The Host-Topography interface module 601 provides the data formatting for the protocol and transport mechanism needed to communicate with the IoT Host Interface Module 330. As such, all of the modules in the IoT Edge Device Discovery may communicate with the IoT Host 110 regardless of the type of connection used to communicate with IoT Host 110.

FIG. 7 illustrates a System Monitor/Failover module within the IoT Host server according to an embodiment of the present invention. The System Monitor/Failover module 325 actively monitors the status of all of the Remote Gateway Devices 120 and all of the IoT edge Devices 130 that are part of the IoT network 103. The System Monitor/Failover module 325 obtains the topography of IoT network 103 from IoT Host Discovery module 305 as well as the primary and alternate communications paths from IoT Host 110 and each of the IoT Edge devices 130.

The System Monitor/Failover module 325 may monitor the status of the devices by monitoring the message traffic that returns to the IoT Host 110 to identify a period of time in which one or more of the devices have not responded that may be greater than a predetermined value. The System Monitor/Failover module 325 may then, or as an alternative to monitoring traffic, may ping each device with a status query message. Failure to receive a response to the query may be used to indicate a failure. The System Monitor/Failover module 325 may attempt to communicate with all of the other devices in a particular communications path to isolate the one or more devices that are failing as well as determine if the failure is related to a communications link between two devices where the devices are otherwise operating.

In other embodiments, Remote Gateway devices 120 may be tasked with the responsibility to monitor the attached IoT Edge devices 130 using a containerized application. This application may transmit the failure information to The System Monitor/Failover nodule 325 to initiate further failover processing. The System Monitor/Failover module 325 includes a Host-Failover Interface module 715, a Node Status Monitoring module 710, a Node Failover module 701, a Node Failover Rules module 705, and an IoT Device Failover Options database 326 coupled to the Node Failover module 701 and the Node Failover rules module 705.

The Host-Failover Interface module 715 is connected to the IoT Host control module 301 to provide a connection from the System Monitor/Failover module 325 to the IoT Host 110. The Host-Failover Interface module 715 provides the data formatting for the protocol and transport mechanism needed to communicate with the IoT Host Interface Module 330. As such, all of the doles in the Host-Failover Interface module 715 may communicate with the IoT Host 110 regardless of the type of connection used to communicate with the IoT Host.

As discussed above, the Node Status Monitoring module 710 may monitor the operating status of each of the devices in IoT network 103 in multiple ways. The Node Status Monitoring module 710 implements the chosen monitoring mechanism, determines the failure in as much detail as is possible, and initiates a failover operation.

The Node Failover module 701 performs a failover operation once identified by the Node Status Monitoring module 710. The Node Failover module 701 determines all of the functions to be provided by the failed device, determines one or more possible reconfigurations of the devices within IoT network 103, and initiates a reconfiguration of the effected devices to implement the reconfiguration. The Node Failover module 701 interacts with the Node Failover Rules module 705 when identifying the type of reconfiguration to be implemented. For example, if IoT network 103 possesses an available inactive backup device for the failed device, the Node Failover Rules module 705 may instruct the Node Failover module 701 to utilize the available device. Similarly, if IoT network 103 possesses multiple communications paths to all of the IoT Edge devices 130 that correspond to a no longer working communications path that went thru a failed Remote Gateway device 120, the Node Failover Rules module 705 may instruct the Node Failover module 701 to reconfigure the primary communications paths used to support the IoT Edge devices 130. When reconfiguring a Remote Gateway device or the communications paths passing thru the Remote Gateway, if there are any containerized applications within the failed Remote Gateway device, then those applications may need to be added to other devices taking over for the reconfigured Remote Gateway device's function. The Node Failover module 701ensures that all of these operations are successfully implemented.

In one embodiment, the Node Failover module 701 may communicate with the Gateway Configuration module 310 to request that a reconfiguration operation occur. The reconfiguration of devices and primary communications paths is similar to the initial configuration of these devices that is performed by the Gateway Configuration module 310 at startup. In an alternate embodiment, the Node Failover module 701 may directly communicate with the devices to be reconfigured in a manner that is similar to the original configuration to ensure that the reconfiguration takes into account the current operations being performed with the devices to be reconfigured. In the latter case, the Node Failover module 701 may obtain any data and containerized applications needed for the reconfiguration operations from the Gateway Configuration module 310.

The Node Failover Rules module 705 processes a set of reconfiguration rules from a set of rules in the IoT Device Failover Options database 326 that it determines are applicable to the type of failover situation that has been detected. By processing the applicable set of rules, a failover configuration is returned to the Node Failover module 701 for implementation.

Both the Node Failover module 701 and the Node Failover rules module 705 access the database 326 to identify alternatives for the device that has failed. The database 326 may contain information regarding the devices in IoT networks 102-103, the functions performed by each of these devices, the containerized applications that may be used in Remote Gateway devices 120 to support particular IoT edge devices 130 attached to each of the Remote Gateway devices 120, as well as failover options corresponding to one or more of the expected configuration options for all of the devices within IoT networks 102-103.

FIG. 8a illustrates a Gateway Configuration module within the IoT Host server as an example embodiment of the present invention. The Gateway Configuration module 310 generates all of the configuration data, containerized applications, primary and alternate communications paths, and gateway device functionality required to configure all of the devices within IoT network 103. The Gateway Configuration module 310 includes a Gateway Configuration Control module 801, an IoT Host-Configuration Interface module 805, an Operator Configuration Interface module 822, a an IoT Network User ConfigurationNerification module 833, a Gateway Routing Rules module 810, a Gateway Functionality module 815, and a Gateway Application Configuration module 820 coupled to a Gateway Application database 311.

The Gateway Configuration Control module 801 defines the functionality of the Remote Gateway devices 120 within the IoT networks 102-103 in cooperation with the Gateway Routing Rules module 810, the Gateway Functionality module 815, and the Gateway Application Configuration module 820. The Gateway Configuration Control module 801 also interacts with the Operator Configuration Interface module 822, and the IoT Network User Configuration/Verification module 833 to permit a user to provide input to assist in defining the desired functionality of the devices in the IoT networks 102-103. The Gateway Configuration Control module 801 receives the network topography obtained from the Topography/Redundancy Module 615, the primary and alternate communications paths within the IoT networks 102-103 from Gateway Routing Rules module 810, the functionality to be located within each of the Remote Gateway devices 120 from the Gateway Functionality module 815, and the containerized applications to be used within the Gateway devices 120 from the Gateway Application Configuration module 820.

Using all of this data, the Gateway Configuration Control module 801 creates a set of configuration data for the devices in the IoT networks 102-103. The module 801 uploads all the configuration data and containerized applications to the devices in the IoT networks 102-103 and when all are configured, initiates the enabling of the devices to begin operation.

The IoT Host-Configuration Interface module 805 is connected to the IoT Host control module 301 to provide a connection from the Gateway Configuration module 310 to the IoT Host 110. The IoT Host-Configuration Interface module 805 provides the data formatting for the protocol and transport mechanism needed to communicate with the IoT Host Interface Module 330. As such, all of the modules in the IoT Host-Configuration Interface module 805 may communicate with the IoT Host 110 regardless of the type of connection used to communicate with the IoT Host.

The Operator Configuration Interface module 822 provides a communications interface between the Operator Configuration Interface module 822 and the user configuration terminal 824. The module 822 provides the data formatting for the protocol and transport mechanism needed to communicate with the user configuration terminal 824. As such, all of the modules in the Gateway Configuration module 310 may communicate with the user configuration terminal 824 regardless of the type of connection used to communicate with the user console 302. As noted above, the connection maybe a direct connection, a networked connection, a wired connection, or a wireless connection. Additionally, the Operator Configuration Interface module 822, in alternate embodiments, may communicate with the user console 302 used to control the operation of the IoT Host 110.

The IoT Network User Configuration/Verification module 833 assists a user to configure the IoT network 103 by presenting the user with a representation of a configured IoT network with an ability to vary one or more defining parameters. A user may view a proposed topography for the IoT network 103 and the functionality of the IoT Edge devices 130 as well as the functionality of the Remote Gateway devices 120 to determine if system requirements may be met. The user may vary one or more of the defining parameters and the IoT Network User Configuration/Verification module 833 modifies the display of the proposed IoT network 103 as affected by the parameter modification.

The Gateway Routing Rules module 810 defines the primary and secondary communications paths to be used within the IoT networks 102-103. The Gateway Routing Rules module 810 utilizes the network topography obtained from the Topography/Redundancy Module 615 and its internal rules to determine the primary communications paths for each of the IoT Edge devices 130 to the IoT Host 110. The Gateway Routing Rules module 810 may select the primary communications path by determining the communications path from the IoT Edge device to the IoT Host 110 using a selection criteria. The selection criteria may include the most direct path, the path having the fewest connections, the path having the lowest latency as measured by a determination using the communications bandwidth and estimated message traffic, or a multi-level priority scheme that ensures priority to message traffic depending upon the function of the IoT Edge device 130 and/or the functionality present in a Remote Gateway device 120 in the communications path. Additionally, the Gateway Routing module 810 may also include a process to check the status of all primary and alternate communications paths by forcing message traffic thru each path in order to determine its status. This process may use a round robin, least recently used, or similar methodologies to determine which of the communications paths may he tested at any given time.

All of the identified non-primary communications paths will then be considered alternate paths for use in reconfiguration. Also, a primary communications path may consist of two different identified communications paths that both transport message traffic based upon a real-time estimate of the latency and message congestion present in the multiple paths. The primary communications paths may be determined to support the fastest communications or the use of a minimum number of devices or some combination of both approaches as needed to support the performance of the IoT networks 102-103.

The Gateway Functionality module 815 defines the functionality to be located within each of the Remote Gateway devices 120 to support the needs of the IoT networks 102-103. The Gateway Functionality module 815 utilizes the network topography obtained from the Topography/Redundancy Module 615, the primary communications paths for each of the IoT Edge devices 130 to the IoT Host 110 from the Gateway Routing Rules module 810, and its own internal rules to define the functionality for each Remote Gateway device 120. The Gateway Functionality module 815 may select functions needed by determining the data processing needs for data received from the IoT Edge devices 130 before passage to the IoT Host 110 using a selection criteria. The selection criteria may include the number, type, and functions of the IoT Edge devices 130, the available containerized applications from the Gateway Application Configuration module 820, the processing capacity of each Remote Gateway device 120 present within each primary communications path between the IoT Edge devices 130 to be supported by the Gateway device, and the availability of other Remote Gateway devices 120 that are available for load sharing. Once the functionality is defined, the processing communicates with the Gateway Application Configuration module 820 for identification of the containerized applications to be used in configuring the Remote Gateway devices 120.

The Gateway Application Configuration module 820 determines the containerized application(s) to be used in the Remote Gateway devices 120 to provide the needed functionality of the gateway devices. The Gateway Application Configuration module 820 is coupled to the Gateway Application database 311 to obtain the possible applications needed to implement the gateway functionality as defined within the Gateway Functionality module 815. The Gateway Application Configuration module 820 and the Gateway Application database 311 may possess all of the containerized applications available for use in the IoT networks 102-103. If the requirements for the Remote Gateway device's applications depend upon characteristics of the individual Remote Gateway device such as support for a particular operating system or version of a Gateway device, the Gateway Application database 311 may contain the needed versions for an application for each of these possible variations.

FIG. 8b illustrates an IoT Network User Configuration Verification module within the IoT Host server as an example embodiment of the present invention. The IoT Network User ConfigurationNerification module 833 assists a user to configure the IoT network 103 by presenting the user with a representation of a configured IoT network with an ability to vary one or more defining parameters. These parameters may include, the number of device types contained within primary communications paths thru the particular Gateway Device, an estimated amount of message traffic and corresponding data to be passing thru the particular Gateway Device, an estimate of the processing requirements for the estimated amount of traffic and data, and the resources available in other Remote Gateway devices. These parameters may also may include the most direct communications path, the communications path having the fewest connections, the communications path having the lowest latency as measured by a determination using the communications bandwidth and estimated message traffic, or a multi-level priority scheme that ensures priority to message traffic depending upon the function of the IoT Edge device 130 and/or the functionality present in a Remote Gateway device 120 in the communications path, and any other factor used in the routing and application configuration.

The IoT Network User Configuration/Verification module 833 includes an IoT Network Display Control module 841, an IoT Network Parameters module 842, IoT Network Display Rendering module 843, and an IoT Device Configuration module 844. The IoT Network Display Control module 841 is coupled to the Operator Interface module 822 to provide display data to the user terminal 824 and to receive user commands from the user terminal 824 to modify the defining parameters of the IoT network 102-103. The IoT Network Display Control module 841 also coordinates the processing of the other modules within the TOT Network User Configuration/Verification module 833 to generate the proposed topography for the IoT network 103 and the functionality of the IoT Edge devices 130 as well as the functionality of the Remote Gateway devices 120. The IoT Network Display Control module 841 receives user commands and processes them to change the defining parameters for IoT network 102-103 and its proposed configuration.

The IoT Network Parameters module 842 presents the defining parameters for IoT network 102-103 to the user via the user terminal 824 in a graphical form. The user may interact with the defining parameter settings to change the configuration of the IoT network 102-103. The IoT Network Display Control module 841 may display any or all of the defining parameters grouped into logical collections of similar parameters. Each defining parameter may be represented by a graphical user interface object such as a user controlled slider, a user modifiable numeric value, a user controlled dial or similar user interface object that permits the modification of each defining parameter within a predefined range of values. Once the user modifies one or more defining parameters, the IoT Network Display Control module 841 receives the updated parameters and causes the proposed topography and device functionality to be updated.

The IoT Network Display Rendering module 843 generates a visual representation of the topography and device functionality for the proposed IoT network 102-103 using the current values for the defining parameters and presents the visual representation to the user on the user terminal 824. Each time the defining parameters are updated, the IoT Network Display Rendering module 843 generates a new visual representation of the topography and device functionality for the proposed IoT network 102-103.

The IoT Device Configuration module 844 generates all of the configuration data for the devices within the IoT network 102-103 once the user is satisfied with the topography and device functionality for the proposed IoT network 102-103. The module 844 may perform the configuration directly or use the Gateway Configuration module 310 discussed in reference to FIG. 8a. The configuration data and corresponding containerized applications may he uploaded to the devices within IoT network 102-103 to initiate operation of the network.

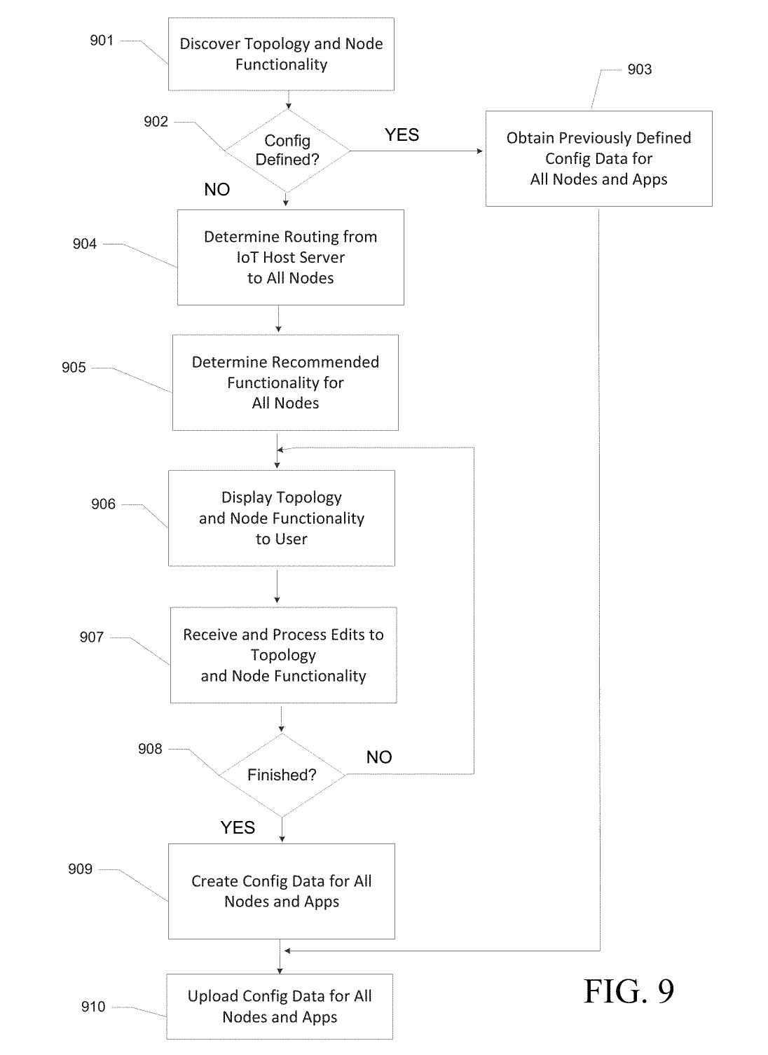

FIG. 9 illustrates a flowchart of possible operations that may be performed according to an embodiment of the present invention. The processing begins with the discovery of the topography and node functionality for the devices within IoT network 103 in block 901. With the topography, decision block 902 determines whether a pre-defined configuration exists for the detected IoT network. If block 902 determines a pre-defined configuration exists, the configuration data and containerized applications for all of the devices in IoT network 103 is obtained in block 903. The processing then flows to block 910 in which the configuration data and applications are uploaded to the network devices and the IoT Network may begin operation.

If block 902 determines that a pre-defined configuration does not exist, or is instructed by a user to modify a configuration, block 904 determines all of the possible routing of communication paths within IoT network 103 from IoT Host 110 to IoT Edge devices 130. Recommendations for primary and alternate communications paths may be determined in Block 904 as well.

Block 905 next determines a set of recommended functionality for each device in the IoT network 103. Block 905 may determine which containerized applications may be installed within the Remote Gateway devices 120 to support the recommended primary communications paths. Block 905 may also determine which, if any, of the devices are redundant and are to be left in a standby state for use should a failover event occur.

Block 906 generates a visual representation for the network topography and device functionality based upon the current set of recommendations generated above. The visual representation is presented to the user via the user terminal 824 for inspection and analysis. The user may modify one or more of the defining parameters used to generate the current set of recommendations and transmit the modifications in block 907. Block 907 modifies the set of recommendations based upon the changes to the defining parameters and then generates a modified visual representation for the network topography and device functionality. This modified visual representation for the network topography and device functionality is displayed to the user for additional inspection and analysis.

Decision block 908 determines whether the user indicates the acceptance of the current set of recommendations for device functionality and communications. If accepted, the processing flows to block 909 wherein the configuration data and containerized applications for all of the devices in IoT network 103 is generated. The processing then flows to block 910 in which the configuration data and applications are uploaded to the network devices and the IoT network may begin operation.

If decision block 908 determines that the user has not accepted the current state of the set of recommendations for device functionality and communications, the processing returns to block 906 for additional input from the user to modify the IoT network 103. The processing will iteratively loop through these processing steps until the user is satisfied with the IoT network 103.

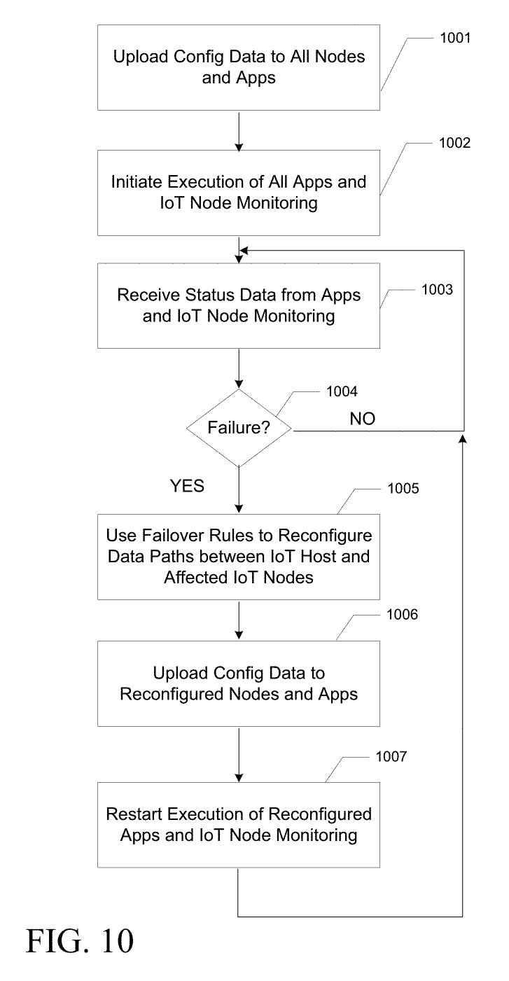

FIG. 10 illustrates a flowchart of possible operations that may be performed by an IoT network according to an embodiment of the present invention. Block 1001 begins the process by uploading all of the configuration data and containerized applications from IoT Host 110 to the Remote Gateway devices 120 and the IoT Edge devices 130. Block 1002 initiates the enabling of all of the IoT network devices to begin the functionality of the network.

Block 1003 receives status data from all containerized applications and IoT Node Monitoring modules. Decision block 1004 determines whether a failure has occurred within IoT network 103. If no failure has been detected, the processing returns to block 1003 to continue monitoring the IoT network status.

If block 1004 determines that a failure has been detected, block 1005 determines the location and scope of the failure and then utilizes the Failover Rules to reconfigure primary communications paths between the IoT Host 110 and the IoT Edge devices 130. Block 1005 may also reconfigure one or more Remote Gateway devices 120 as needed.

Block 1006 uploads the configuration data and containerized applications needed to implement the reconfiguration of IoT network 103. In this process, only the affected nodes in the network may receive data in one embodiment if the functioning devices are still in operation. In alternate embodiments, all of the devices may be halted and receive a set of updated configuration data, if needed, to keep the entire network operation synchronized. Once all of the devices are reconfigured, block 1007 may restart the network and return to monitoring the status of the devices in block 1003.

While the above embodiments of the present invention describe the interaction of System and Method for Providing Secure and Redundant Communications and Processing for a Collection of Internet of Things (IoT) Devices, someone skilled in the art will recognize that the use of software within programmable servers may be replaced with firmware or programmable logic within the network devices. It is to be understood that other embodiments may be utilized and operational changes may be made without departing from the scope of the present invention.

Someone of ordinary skill in the art will appreciate that any process or method descriptions herein may represent modules, segments, logic or portions of code which include one or more executable instructions for implementing logical functions or steps in the process. It should be further appreciated that any logical functions may be executed out of order from that described, including substantially concurrently or in reverse order, depending on the functionality involved, as would be understood by those reasonably skilled in the art. Furthermore, the modules may be embodied in any non-transitory computer readable medium for use by or in connection with an instruction execution system, apparatus, or device, such as a computer-based system, processor-containing system, or other system that can fetch the instructions from the instruction execution system, apparatus, or device and execute the instructions. It will be apparent to those skilled in the art that many changes and substitutions can be made to the embodiments described herein without departing from the spirit and scope of the disclosure as defined by the appended claims and their full scope of equivalents.

What is claimed is:

1. A method for configuring a set of network devices, the method comprising:
a non-transitory computer-readable medium comprising a set of instructions that when executed by a programmable computing device causes the computing device to implement a method for configuring a set of network devices, the method comprising:
discovering all devices within an IoT network, the IoT network comprising an IoT Host computer, one or more gateway devices, and a plurality of IoT Edge devices;
recommending a network topography and node functionality using a set of defining parameters;
obtaining configuration data and functionality modules for use n the IoT network; and
uploading configuration data and functionality modules from the IoT Host to the IoT Edge devices and the IoT gateway devices.

2. The method according to claim 1, wherein the method further comprises:
monitoring the status of devices within the IoT network; and
when a failure of a device is detected within one or more IoT devices within the IoT network:
determining the location and extent of the device failure;
determining a set of device reconfiguration arrangements to functionally replace the failed devices;
obtaining the configuration data and functionality modules for the set of device reconfiguration arrangements; and
uploading configuration data and functionality modules for the set of device reconfiguration arrangement from the IoT Host to the IoT Edge devices and the IoT gateway devices.

3. The method according to claim 2, wherein the IoT gateway devices comprise a network switch including a programmable computing system.

4. The method according to claim 3, wherein the functionality modules comprise a containerized application executable on the gateway device.

5. The method according to claim 1, wherein the IoT Edge devices comprise a data sensor capable of data communications to the IoT Host.

6. The method according to claim 5, wherein the IoT Edge devices being coupled to the gateway devices using a first communications protocol.

7. The method according to claim 6, wherein the gateway devices being coupled to the IoT Host over a shared communications network using a second communications protocol.

8. A computer program product for configuring a set of network devices, comprising:
is a non-transitory computer-readable medium comprising a set of instructions that when executed by a programmable computing device causes the computing device to implement a method for configuring a set of network devices, the method comprising:
discovering all devices within an IoT network, the IoT network comprising an IoT Host computer, one or more gateway devices, and a plurality of IoT Edge devices;
recommending a network topography and node functionality using a set of defining parameters;
obtaining configuration data and functionality modules for use within the IoT network; and
uploading configuration data and functionality modules from the IoT Host to the IoT Edge devices and the IoT gateway devices.

9. The computer program product according to claim 8, wherein the method further comprises:
monitoring the status of devices within the IoT network; and
when a failure of a device is detected within one or more IoT devices within the IoT network:
fining the location and extent of the device failure;
determining a set of device reconfiguration arrangements to replace the failed devices;
obtaining the configuration data and functionality modules for the set of device reconfiguration arrangements; and
uploading configuration data and functionality modules for the set of device reconfiguration arrangement from the IoT Host to the IoT Edge devices and the IoT gateway devices.

10. The computer program product according to claim 9, wherein the IoT gateway devices comprise a network switch including a programmable computing system.

11. The computer program product according to claim 10, wherein the functionality modules comprise a containerized application executable on the gateway device.

12. The computer program product according to claim 8, wherein the IoT Edge devices comprise a data sensor capable of data communications to the IoT Host.

13. The computer program product according to claim 12, wherein the IoT Edge devices being coupled to the gateway devices using a first communications protocol.

14. The computer program product according to claim 6, wherein the gateway devices being coupled to the IoT Host over a shared communications network using a second communications protocol.

15. A distributed computing system, having an IoT Host Computer, one or more Gateway devices, and a plurality of IoT Edge devices, for configuring a set of network devices, the IoT Host computer comprising:
an IoT Device Discovery module for discovering all devices within an IoT network, the IoT network comprising an IoT Host computer, one or more gateway devices, and a plurality of IoT Edge devices;
a Gateway Configuration module for recommending a network topography and node functionality using a set of defining parameters;
an IoT Device Configuration module for displaying an updated visual representation of the network topography and node functionality to a user terminal based upon the modifications to the one or more of the defining parameters; and
IoT Host control module for uploading configuration data and functionality modules to the IoT Edge devices and the IoT gateway devices.

16. The distributed computing system according to claim 15, wherein the IoT gateway devices comprise a network switch including a programmable computing system.

17. The distributed computing system according to claim 16, wherein the functionality modules comprise a containerized application executable on a programmable gateway device.

18. The distributed computing system according to claim 15, wherein the IoT Edge devices comprise a data sensor capable of data communications to the IoT Host.

19. The distributed computing system according to claim 18, wherein the IoT Edge devices being coupled to the gateway devices using a first communications protocol.

20. The distributed computing system according to claim 19, wherein the gateway devices being coupled to the IoT Host over a shared communications network using a second communications protocol.
